(19) United States
(12) Patent Application Publication
(10) Pub. No.: US 2019/0294234 A1
(43) Pub. Date: Sep. 26, 2019

(54) TOUCH PANEL WIRING STRUCTURE

(71) Applicants: Jhih-Ciang Bai, Taoyuan (TW); Meng-Guei Lin, Taoyuan (TW); Cing-Fong Lin, Taoyuan (TW); Jin-An Cai, Taoyuan (TW); Yi-Jing Huang, Taoyuan (TW)

(72) Inventors: Jhih-Ciang Bai, Taoyuan (TW); Meng-Guei Lin, Taoyuan (TW); Cing-Fong Lin, Taoyuan (TW); Jin-An Cai, Taoyuan (TW); Yi-Jing Huang, Taoyuan (TW)

(73) Assignee: Young Fast Optoelectronics Co., Ltd., Taoyuan (TW)

(21) Appl. No.: 15/925,836

(22) Filed: Mar. 20, 2018

(51) Int. Cl. G06F 3/01

(52) U.S. Cl. CPC G06F 3/01

(57) ABSTRACT

The invention includes a glass plate, a bezel layer, a touch sensor layer and a signal wire layer. The bezel layer attached on a periphery of the glass plate defines a shaded area and a visible area. The touch sensor layer has sensing columns arranged in the visible area. Each of the sensing columns includes a common sensing electrode and a plurality of driving electrodes. The driving electrodes are divided into two electrode columns. Each driving electrode of the electrode columns is connected to a bridging point in one of two opposite side of the shaded area through a connecting wire. All the bridging points in a line are electrically connected by a bridging film connected to a part of the contacts of the connecting port through the signal wire layer. The common sensing electrodes are electrically connected to another part of the contacts through the signal wire layer.

### BACKGROUND OF THE INVENTION

### 1. Technical Field

The invention relates to capacitive touch panels, particularly to a capacitive touch panel with a single wire layer.

### 2. Related Art

For the sake of structure simplification and cost reduction, many touch panels integrate a touch sensing structure on a cover plate. For example, the touch panels with the G1 framework form a bezel layer, a touch sensor layer and a signal wire layer on the bottom side of a transparent glass cover plate. Some designs further add an insulative protection layer under these layers. The bezel layer is an opaque film on a periphery of the glass cover plate to define a shaded area and a visible area within the shaded area. The touch sensor layer is arranged in the visible area. The signal wire layer is arranged in the shaded area and has signal wires separately electrically connecting driving electrode and sensing electrodes of the touch sensor layer. As a result, touch signals of the touch sensor layer can be transmitted a subsequent processor through the signal wire layer.

Such a touch panel with the G1 framework has a single touch sensor layer, i.e., all of driving electrodes and sensing electrodes are disposed on the same layer. In addition, each electrode is connected to a peripheral portion through a wire and then connected to the signal wire layer. Currently, an available approach is to aggregate all wires to a single side portion. However, the touch sensor layer usually has hundreds of driving electrodes and sensing electrodes. In other words, hundreds of contacts are aggregated to a single side portion. As a result, this side portion must be wide enough to accommodate them. Such an excessively wide bezel will impair appearance and enlarge an ineffective area. Furthermore, this will be adverse to narrowing of bezel.

### SUMMARY OF THE INVENTION

An object of the invention is to provide a touch panel wiring structure, which can diminish the wiring area of side portions to narrow the width of the bezel and enlarge the area of the operatable region.

To accomplish the above object, the touch panel wiring structure of the invention disposes a bezel layer, a touch sensor layer and a signal wire layer on a glass plate. The bezel layer is an opaque film on a periphery of the glass plate to define a shaded area and a visible area within the shaded area. The touch sensor layer has sensing columns arranged in the visible area. The signal wire layer is electrically connecting the touch sensing columns to contacts of a connecting port. Each of the sensing columns comprises a common sensing electrode and a plurality of driving electrodes. The plurality of the driving electrodes are divided into two driving electrode columns. Each driving electrode of the two driving electrode columns is electrically connected to a bridging point arranged in one of two opposite side of the shaded area through an electrode connecting wire. All the bridging points in a line are electrically connected by a bridging film. The bridging film is electrically connected to a part of the contacts of the connecting port through the signal wire layer. The common sensing electrodes are electrically connected to another part of the contacts of the connecting port directly through the signal wire layer.

### BRIEF DESCRIPTION OF THE DRAWINGS

FIG. 1 is an exploded view of the invention;

FIG. 2 is an assembled bottom view of the invention;

FIG. 3 is an assembled top view of the invention;

FIG. 4 is a schematic view of the invention, which shows wiring of the touch sensors and signal wire layer; and

FIG. 5 is an enlarged view of circle A in FIG. 2.

### DETAILED DESCRIPTION OF THE INVENTION

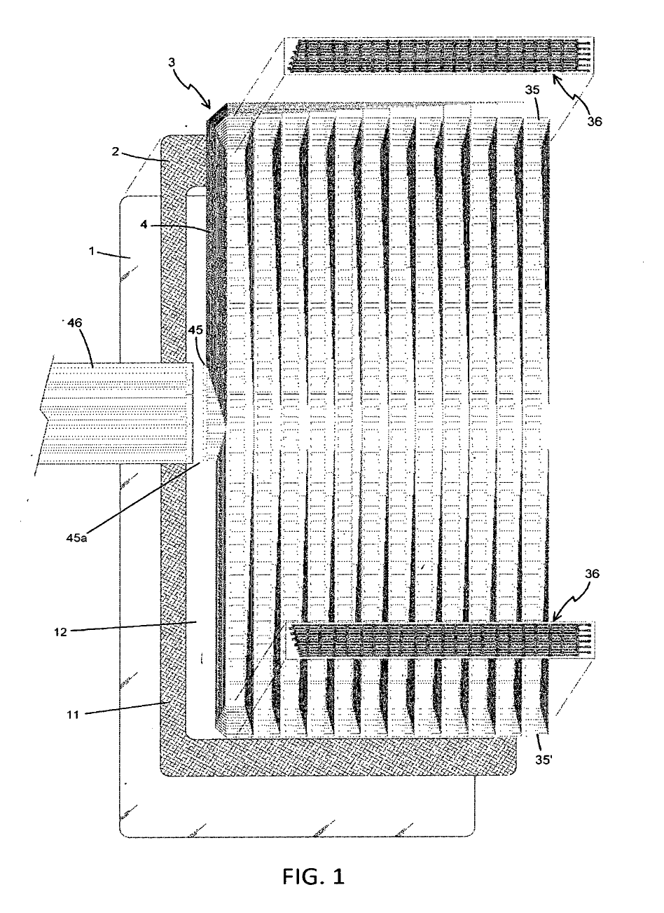

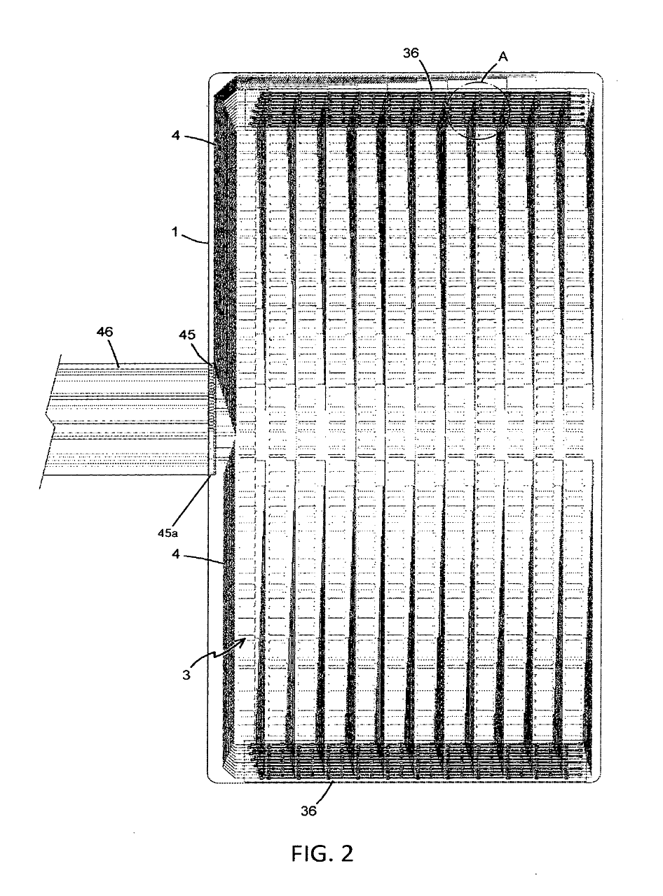

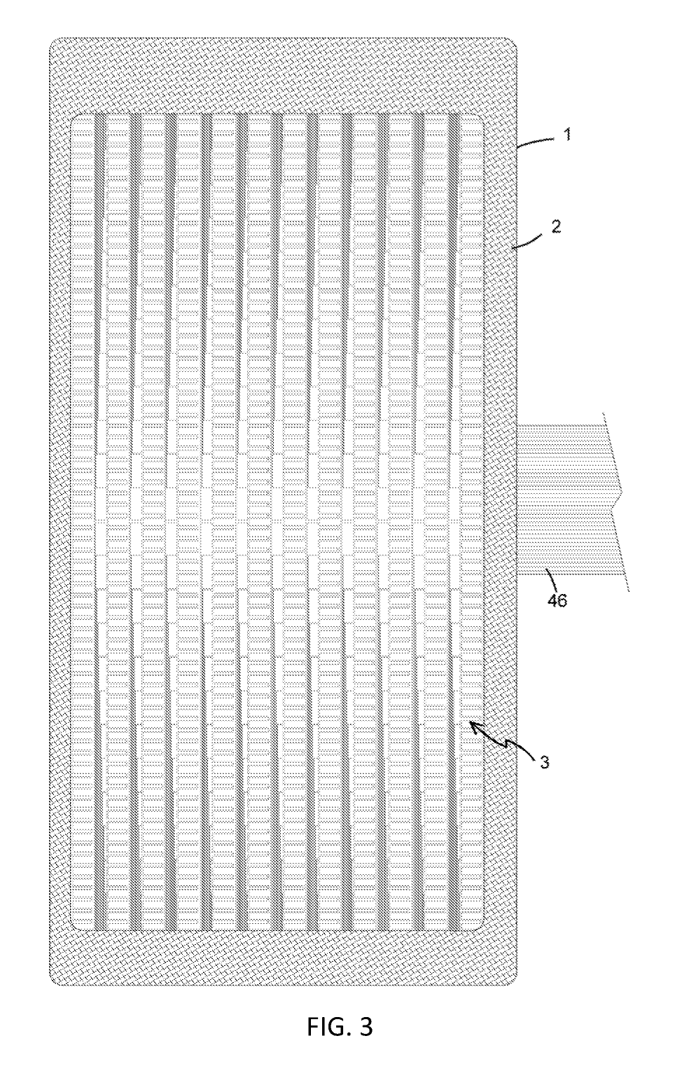

Please refer to FIGS. 1-3. The invention includes a glass plate 1, a bezel 2, a transparent touch sensor 3 and a signal wire layer 4. The glass plate 1 is a thin plate with high transparency and great mechanical strength and is made of, but limited to, glass, poly(methyl methacrylate) (PMMA), polycarbonate (PC), polyethylene terephthalate (PET) or cyclic olefin copolymer (COC). The bezel 2 is disposed on a periphery of the bottom of the glass plate 1 and is formed by an opaque insulative film which may be made of ink or photoresist. Thickness of the insulative film, which is formed by printing, sputtering or coating, is about 15 μm. As a result, a shaded area 11 is formed by the film and a visible area 12 within the shaded area 11 is also formed.

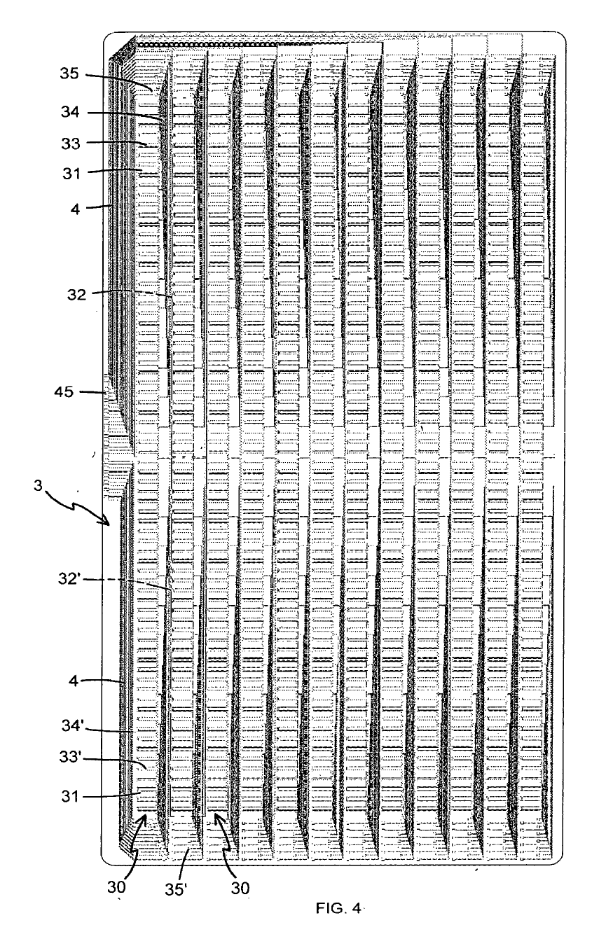

Please refer to FIG. 4. The transparent touch sensor 3 is a projected capacitive touch sensor composed of sensing columns 30 arranged in a bottom side of the visible area 12. Each of the sensing columns 30 includes a common sensing electrode 31 and two driving electrode columns 32, 32′. The two driving electrode columns 32, 32′ are arranged in a symmetric manner. Each driving electrode column 32, 32′ has multiple driving electrodes 33, 33′. The common sensing electrode 31 and the driving electrodes 33, 33′ are arranged in a complementary pattern. In this embodiment, the common sensing electrode 31 is of a rectangular jagged shape and the driving electrodes 33, 33′ are shaped into rectangular blocks separately located in recesses of the rectangular jagged common sensing electrode 31 at intervals. The driving electrodes 33, 33′ of the driving electrode columns 32, 32′ are separately electrically connected to a bridging point 35, 35′ arranged in one of two opposite side portions of the shaded area 11 through an electrode connecting wire 34, 34′. In other words, there are two groups of bridging points 35, 35′ in two opposite side portions. The common sensing electrode 31 is electrically connected to a contact 45 in a connecting port through a silver path on the signal wire layer 4. The touch sensor 3 is made of a material with high transparency, such as an indium tin oxide, indium zinc oxide, aluminum zinc oxide, polyethylenedioxythiophene thin film or metal mesh. Preferably, the touch sensor 3 is directly disposed on the glass plate 1 by etching or laser means.

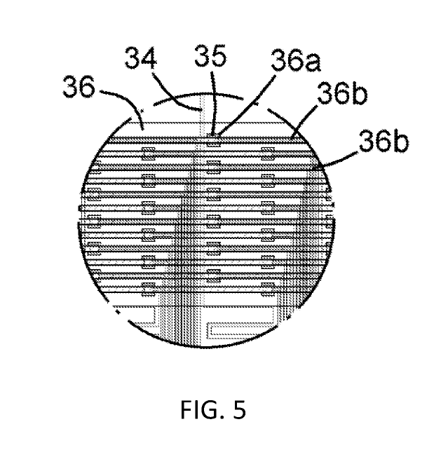

Please refer to FIGS. 1, 2 and 5. The bridging points 35, 35′ are located in the shaded area 11 of the glass plate 1. The bridging points 35, 35′ are covered by a bridging film 36. The bridging film 36 is formed with through holes 36b corresponding to positions of the bridging points 35, 35′. A bridging wire 36b is connected between each two adjacent through holes 36a to connect all the bridging points 35, 35′ in the same X-axis by separately inserting the bridging wires 36b into the through holes 36a. As a result, all the bridging points 35, 35′ in the X-axis can be electrically connected to the silver path of the signal wire layer 4. The silver path of the signal wire layer 4 is electrically connected to the contacts 45 of the connecting port within the shaded area 11. The contacts 45 are located in a side portion of the shaded area 11, but this side portion is different from the side portion in which the bridging points 35, 35′ are located. The contacts 45 are used for connecting a flexible flat cable 46.

The invention divides the driving electrodes into two driving columns 32, 32′ and separately connects their electrode connecting wires 34, 34′ to two groups of bridging points 35, 35′ in two different side portions. This can diminish a single side portion with an excessive width. Also, the bridging points 35, 35′ are electrically connected by the bridging film 36, so that the number of the sliver paths on the signal wire layer 4 can be decreased and a width of the shaded area 11 can be shrunk.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A touch panel wiring structure comprising:
a transparent glass plate;
a bezel layer, attached on the glass plate, and being an opaque film on a periphery of the glass plate to define a shaded area and a visible area surrounded by the shaded area;
a touch sensor layer, attached on the bezel layer, and having sensing columns arranged in the visible area; and
a signal wire layer, attached on the touch sensor layer;
wherein each of the sensing columns comprises a common sensing electrode and a plurality of driving electrodes, each common sensing electrode is electrically connected to a contact of a connecting port through a signal path on the signal wire layer, the plurality of the driving electrodes are divided into two driving electrode columns, each driving electrode of one of the two driving electrode columns is electrically connected to a bridging point arranged in one of two different sides of the shaded area through an electrode connecting wire, each driving electrode of another one of the two driving electrode columns is electrically connected to another bridging point arranged in another one of two different sides of the shaded area through another electrode connecting wire, all the bridging points in a line are electrically connected by a bridging film, the bridging film is electrically connected to a part of the contacts of the connecting port through the signal wire layer, and the common sensing electrodes are electrically connected to another part of the contacts of the connecting port directly through the signal wire layer.

2. The touch panel wiring structure of claim 1, wherein the signal wire layer has sliver paths for conducting electricity.

3. The touch panel wiring structure of claim 1, wherein the two different sides of the shaded area are two opposite sides.

4. The touch panel wiring structure of claim 1, wherein the bridging film is formed with through holes corresponding to positions of the bridging points, and a bridging wire is connected between each two adjacent through holes to connect all the bridging points in a line by separately inserting the bridging wires into the through holes.
